(19) United States
(12) Patent Application Publication
(10) Pub. No.: US 2015/0286374 A1
(43) Pub. Date: Oct. 8, 2015

(54) Embedded System User Interface Design Validator

(71) Applicant: Altia, Inc., Colorado Springs, CO (US)

(72) Inventors: Kevin S. Dibble, Bellingham, WA (US); James J. Mikola, South Lyon, MI (US); Timothy A. Day, Colorado Springs, CO (US)

(21) Appl. No.: 14/677,651

(22) Filed: Apr. 2, 2015

Related U.S. Application Data
(60) Provisional application No. 61/975,158, filed on Apr. 4, 2014.

(51) Int. Cl. G06F 3/0484; G06F 3/0481

(52) U.S. Cl. CPC G06F 3/04842; G06F 3/04847; G06F 3/0481

(57) ABSTRACT

Novel tools and techniques for generating and/or validating user interface designs for embedded systems.

### CROSS REFERENCE TO RELATED APPLICATIONS

This application claims the benefit, under 35 U.S.C. §119, of provisional U.S. Patent Application Ser. No. 61/975,158, (the “'158 Application”) filed Apr. 4, 2014 by Kevin S. Dibble et al. (attorney docket no. 0634.01PR), entitled, “Embedded System User Interface Design Validator,” the entire disclosure of which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND

An “embedded system” is a computer with a dedicated function that operates within a more complex system, which can be mechanical or electrical (including a larger computer system) in nature, with the embedded system “embedded” as part the more complex system that also includes other hardware and/or mechanical components. Examples of embedded systems include vehicle control systems and instrument clusters (which are discussed in further detail in this document and in the '158 Application), many other examples exist as well, including without limitation systems embedded in household appliances, industrial equipment, and the like.

Relative to general purpose computers, embedded systems typically are characterized by low power consumption, small size, and/or low cost. These advantages, however, are balanced the limited processing resources available to such systems, with the result that embedded systems often are significantly more difficult to program and to interface with than general purpose computers. Consequently, many embedded systems did not provide user interfaces. If such interfaces were required, they often were quite simple in nature, such as physical switches, analog displays, and/or the like.

More recently, however, embedded systems have become increasingly complex and many offer a far higher degree of user interaction. One example is an instrument gauge cluster for an automobile. In the past, such clusters generally have been groups of analog gauges with direct input from analog sensors in the vehicle. Now, however, many instrument clusters are computing devices with digital screens (which often emulate analog gauges) and a variety of different user input mechanisms. Automotive manufacturers seek to provide as many features in such devices as possible, subject to a number of restraints, such as the need for real-time output, limited computing resources, and differences between models and platforms.

Hence, there is a need for enhanced tools for the design and implementation of user interfaces for embedded systems, including without limitation embedded systems that implement vehicle instrument clusters.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIGS. 1A, 1B, and 1C are block diagrams illustrating a user interface design system, in accordance with various embodiments.

FIG. 2 is a process flow diagram illustrating a method of generating a user interface, in accordance with various embodiments.

FIG. 3 is a generalized schematic diagram illustrating a computer system, in accordance with various embodiments.

FIG. 4 is a block diagram illustrating a networked system of computers, which can be used in accordance with various embodiments.

### DETAILED DESCRIPTION OF CERTAIN EMBODIMENTS

A set of embodiments provides tools and techniques to enable the design of user interfaces, including a particular user interfaces for embedded systems. In one aspect, for example, such tools can be used to design a user interface for an automobile control system. An automobile control system can be any system that provides for user interaction with an automobile. For example, an automobile control system, in some embodiments, can enable a user to interact with an entertainment system for the automobile, display digitally rendered gauges for the automobile, and/or provide any other digital control interface for the automobile. In some cases this user interface can be provided through a touchscreen and/or through other manipulable controls, such as steering wheel switches, central control wheels, and/or the like. In another aspect, such tools can be used to design user interfaces for a variety of different types of embedded systems, such as control systems for medical devices, appliances, and/or the like, which might have a variety of different input and output tools, such as touchscreens or other displays, keyboards, mice, switches, toggles, dials, and/or the like. Altia Design™ commercially available from Altia, Inc. is an example of a user interface design software package and described in further detail in the '158 Application.

In an aspect, some embodiments provide the ability to validate a user interface design against a rule set, which, in some cases, can include rules particular to different targets on which the user interface will run. For instance, a designer might wish to design a user interface that will run on a variety of different types of embedded systems, which might comprise, for example, different processor characteristics, display characteristics and/or user input device characteristics. For example, one embedded system might include a relatively more powerful embedded processor and a touch screen for both display and input purposes, while another embedded system might include a relatively less powerful processor, a non-touch screen display, and a control knob for input. The same user interface design might not work for both types of systems, but it is difficult for a designer of a user interface to know the characteristics of each system on which the interface might be deployed. Hence, certain embodiments can validate the design for the target system on which it should run (or multiple systems, if desired). In addition, however, the rule set might include other rules, which do not relate to specific target systems but might provide more general guidance, such as warnings about user interface designs that are unnecessarily inefficient or the like. In general, certain embodiments can feature several types of validation rules.

The tools provided by various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible and/or non-transitory computer readable media (such as, to name but a few examples, optical media, magnetic media, and/or the like).

For instance, one set of embodiments provides methods. An exemplary method might comprise receiving, at a computer, a selection of a target for a user interface. The method might further comprise identifying, with the computer, one or more rules to validate a design of the user interface. In some embodiments, the method might comprise validating, with the computer, the design of the user interface, based at least in part on the one or more rules.

A method in accordance with another set of embodiments might comprise storing, in a data store, a plurality of validation rules to validate user interface designs for embedded systems. In some embodiments, the method might comprise receiving, with user interface design software running on a computer system, user input, and/or generating, with the user interface design software, a user interface for an embedded application, based at least in part on the user input. In an aspect, the method can include receiving, with the user interface design software, a user selection of a target embedded system on which the user interface will run, the target embedded system having specified characteristics.

The method, in some embodiments, might further comprise selecting, with a validation engine running on the computer system, one or more validation rules from the data store, based at least in part on the user selection of the target embedded system. The method might also include validating, with validation engine, a design of the user interface with the one or more validation rules and/or providing, with the user interface design software, output indicating a validation status of the design of the user interface. In some cases, the method can comprise generating code executable on the target embedded system to implement the user interface.

An apparatus in accordance with another set of embodiments might comprise a non-transitory computer readable medium having encoded thereon a set of instructions executable by one or more computers to perform one or more operations, including without limitation operations in accordance with methods provided by other embodiments. Merely by way of example, the set of instructions might comprise instructions to store, in a data store, a plurality of validation rules to validate user interface designs for embedded systems; instructions to receive user input; instructions to generate a user interface for an embedded application, based at least in part on the user input; instructions to receive a user selection of a target embedded system on which the user interface will run; instructions to select one or more validation rules from the data store, based at least in part on the user selection of the target embedded system; instructions to validate a design of the user interface with the one or more validation rules; and/or instructions to provide output indicating a validation status of the design of the user interface.

A computer system in accordance with another set of embodiments might comprise one or more processors; and a non-transitory computer readable medium in communication with the one or more processors. The medium might have encoded thereon instructions, such as those described above, to name a few examples.

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

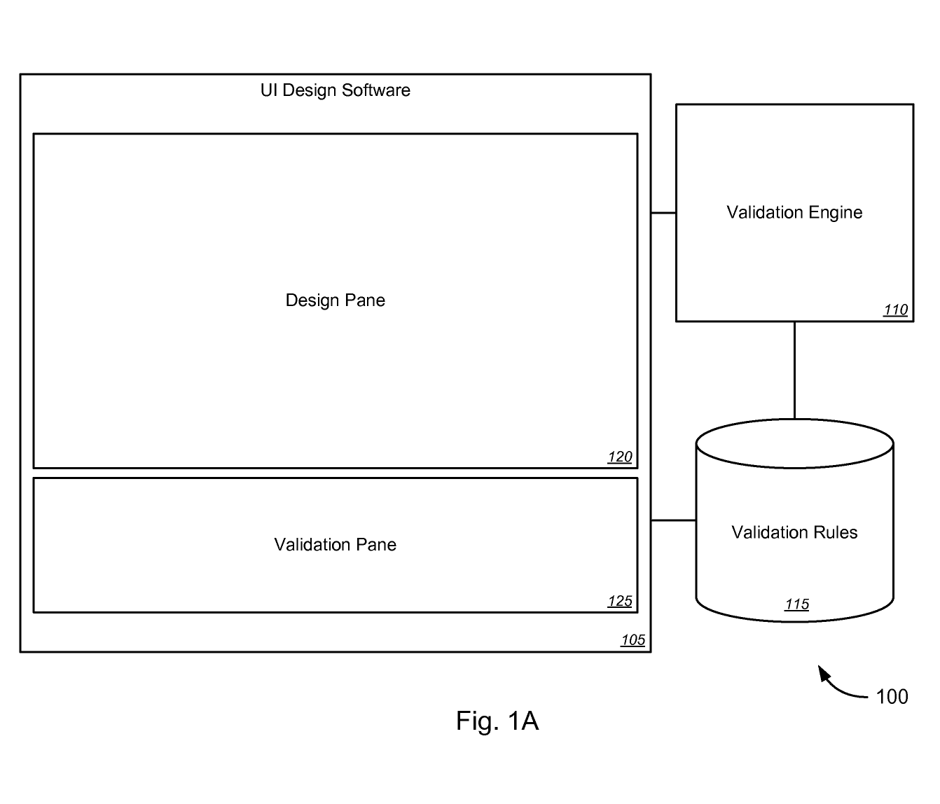

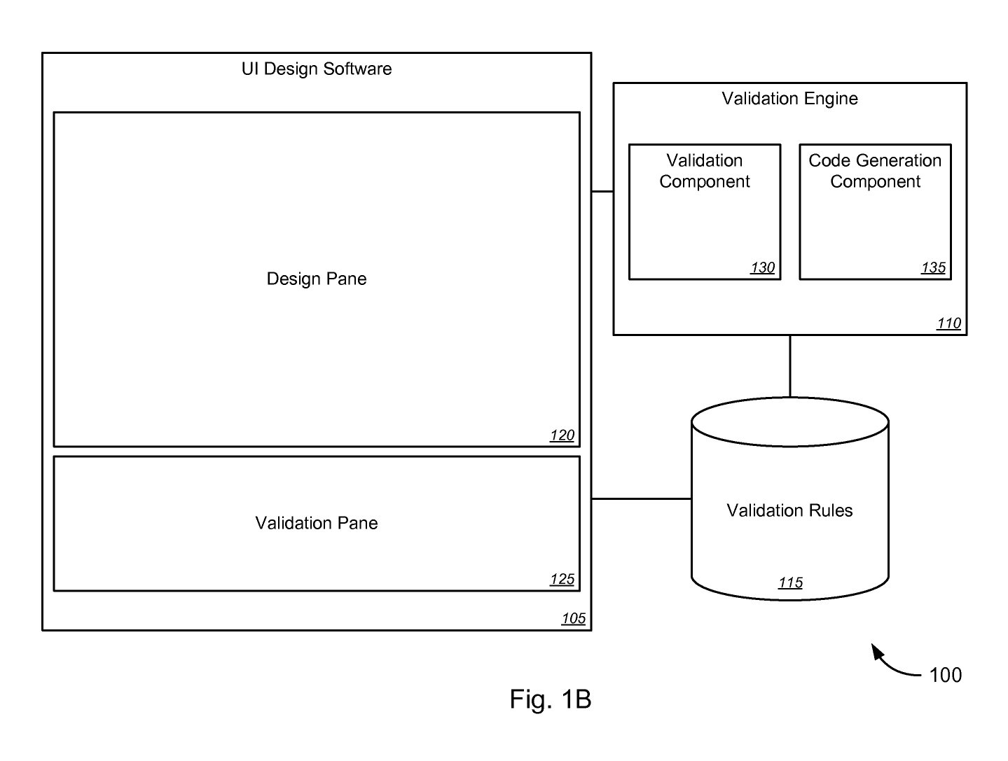

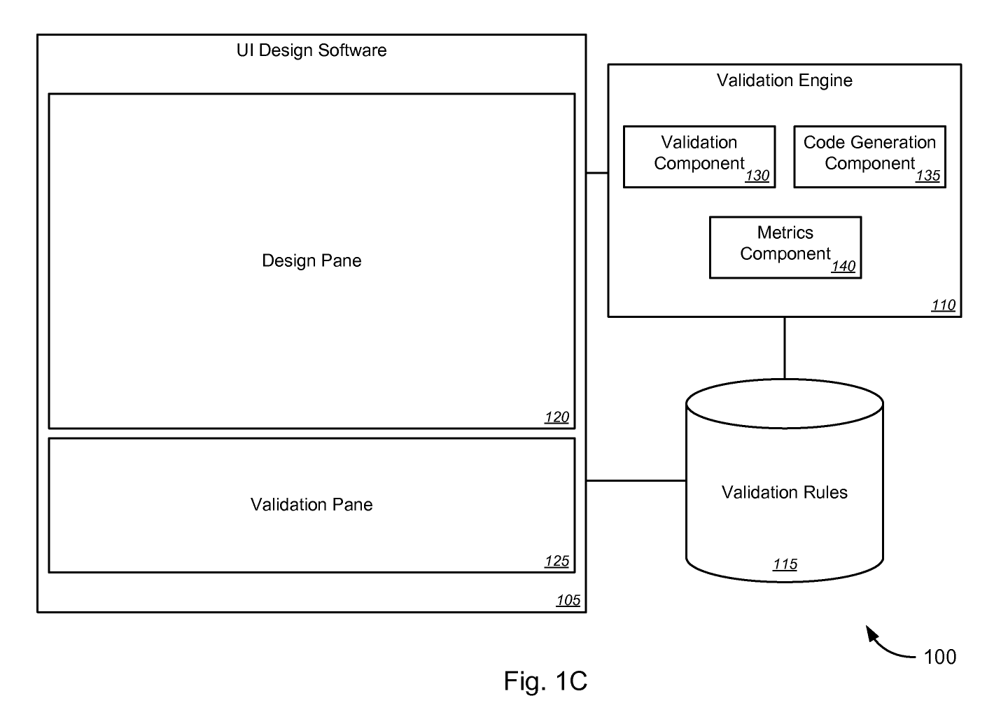

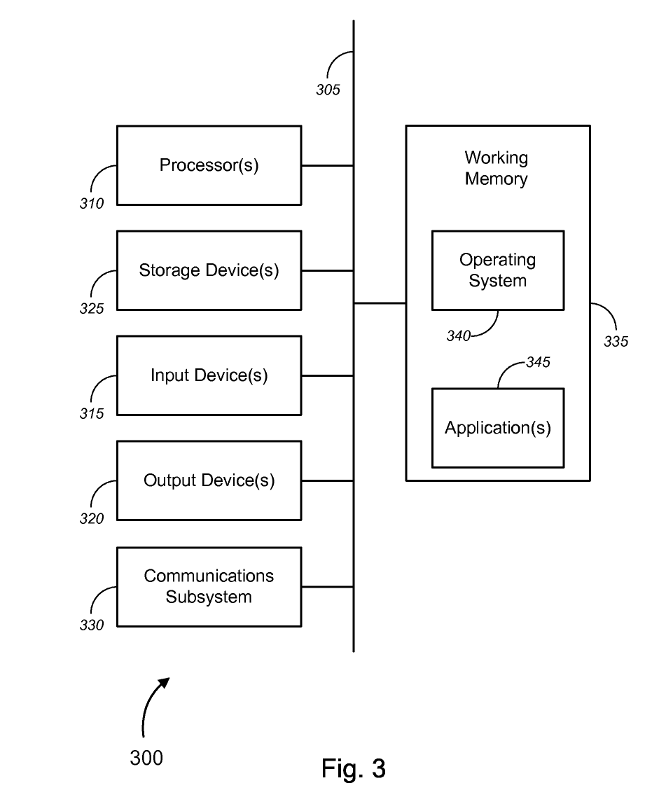

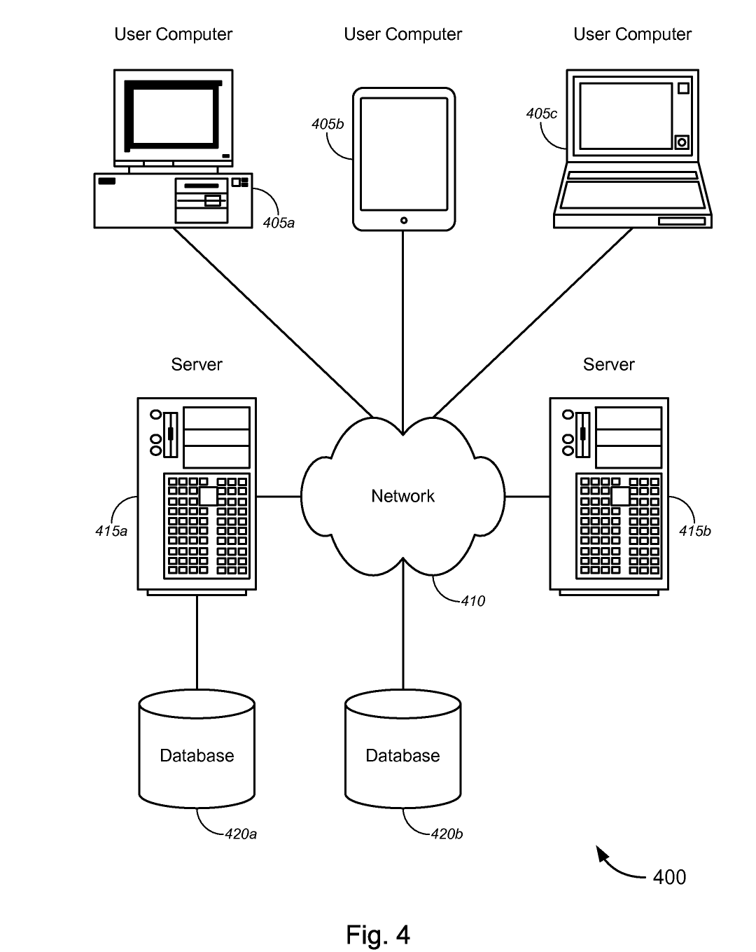

FIG. 1A, for example, illustrates a system 100 that can be used to generate a user interface for an embedded system, such as a system to provide a user interface for an automobile, appliance, and/or the like. The system 100 is illustrated functionally, and can be implemented on a variety of hardware architectures, including without limitation those described below with regard to FIGS. 3 and 4. In the embodiments illustrated by FIG. 1A, the system 100 includes a user interface (“UI”) design software application 105 and a validation engine 110. In some cases, the application 105 might comprise the validation engine 110, while in other cases, the validation engine 110 might be a separate component. The system 100 can further include a data store 115 (which can be a database, such as a relational database, an XML file structure, a file system, or any other appropriate storage structure), which stores a plurality of validation rules. In some cases, the data store 115 might be integrated with the validation engine 110, such that the validation rules are hard coded into the validation engine 110. Examples of several rules are described in Tables 1-3, but these examples should not be considered limiting. Table 1 illustrates examples of general rules that are not specific to a particular target. Table 2 illustrates examples of target-specific rules, and Table 3 illustrates examples of target-specific rules that relate to resource usage of a design on a particular target.

TABLE 1
GENERAL RULES

| Type | Title | Description |
|---|---|---|
| ERROR | Missing File | The file specified in the “name” |
| | | animation of this Object cannot be |
| | | found in the file system. |
| WARNING | Group | This group has been transformed |
| | Transformed | (scaled or rotated) without using an |
| | without | animation. Typically this occurs when |
| | Animation | accidentally grabbing a handle for the |
| | | group instead of grabbing the group |
| | | contents when selecting or moving the |
| | | group on the canvas. |
| | | All objects within this group will be |
| | | drawn with the same transformation |
| | | that currently exists on the group. This |
| | | reduces performance and can cause the |
| | | appearance of objects to be different |
| | | than expected. |
| WARNING | Group Attributes | This group has been assigned graphical |
| | without | attributes (colors, fonts, opacity, etc.) |
| | Animation | without using an animation. Typically |
| | | this occurs when accidentally clicking |
| | | an attribute button on the Home |
| | | Ribbon with an object selected on the |
| | | canvas. |
| | | All objects in this group will be drawn |
| | | with these graphical attributes, |
| | | overriding any attributes for the child |
| | | objects (even if they are animated). |
| WARNING | Defined State for | The animation “XXX” for this object |
| | Intrinsic | is an intrinsic animation which should |
| | Animation | not have any defined states. |
| | | Typically this occurs when |
| | | accidentally clicking the “Define” |
| | | button in the Animation Editor after |
| | | this animation was selected or |
| | | manipulated in the editor. |
| INFO | Intrinsic | The animation “XXX” for this object |
| | Animation | is missing. This is an intrinsic |
| | Deleted | animation which performs object |
| | | specific behaviors. These behaviors |
| | | cannot be actuated without the intrinsic |
| | | animation. |
| | | Typically this occurs when |
| | | accidentally deleted the animation |
| | | from the Animation Editor. |
| WARNING | Zero Alpha | This object has an opacity of 0% |
| | Used to Hide | which makes it not visible. However |
| | | the object is not hidden so it will still |
| | | be processed during draw operations. |
| | | This reduces draw performance. |
| WARNING | Layer Property | This object has a Layer Property which |
| | Used on Child | specifies the hardware layer for |
| | | drawing it and any child objects it |
| | | contains. |
| WARNING | Language Text | The text string in language file “XXX” |
| | Too Big | is too wide for this text object. It |
| | | extends beyond the maximum |
| | | specified pixel width, maximum |
| | | character count, or beyond the pixel |
| | | width of the sibling used for |
| | | justification. |
| ERROR | Font Missing | The Character ‘X’ in the language file |
| | Character | “Y” is not present in the font “Z”. |
| INFO | Object Outside | This object is not within the bounds of |
| | Canvas | the Canvas. It will not appear in a |
| | | runtime emulator and it may not |
| | | appear on the display of embedded |
| | | hardware. |
| | | In addition, it may reduce draw |
| | | performance if not required. |
| WARNING | Text Object Not | This Text Object is set by the language |
| | Constrained | file XXX but does not have a max |
| | | pixel count set. The language |
| | | translation for this text cannot be |
| | | validated against a maximum pixel |
| | | size. |
| WARNING | Language File | The language file “XXX” used with |
| | Very Large | this language object is very large. It |
| | | will take a long time to load, especially |
| | | when running this design on embedded |
| | | hardware. |
| WARNING | Skin File Very | The skin file “XXX” used with this |
| | Large | skin object is very large. It will take a |
| | | long time to load, especially when |
| | | running this design on embedded |
| | | hardware. |
| ERROR | Control Code | The control code for this object |
| | References | references missing file “XXX”. |
| | Missing File | |
| ERROR | Empty Container | This object is a container object but it |
| | | does not contain any child objects. |
| | | This makes the object non-functional. |
| | | In addition it can cause problems with |
| | | size calculations for its parent object. |
| WARNING | Visible Object | This object is visible but completely |
| | Obscured | obscured by another object. This |
| | | object will always be drawn even |
| | | though it will never be seen because |
| | | other objects completely obscure it. |
| | | This reduces draw performance. |
| INFO | Hidden Group | This group has an animation that |
| | Instead of Deck | shows and hides the object. |
| | | This reduces draw performance. |
| WARNING | Image Not | This image has completely transparent |
| | Trimmed | pixels along one or more edges |
| | | resulting in an image that's larger than |
| | | necessary. |
| | | This reduces draw performance and |
| | | increases resource requirements (like |
| | | memory consumption). |
| WARNING | Many Fonts Used | This design contains many sizes of the |
| | | font “XXX”. This increases resource |
| | | requirements (like memory |
| | | consumption) |
| INFO | Large Font | The font “XXX” is a very large font |
| | | with thousands of characters. Make |
| | | sure to set the font range flag in |
| | | the .gen file for your Target. |
| ERROR | WHEN Block | The WHEN block for animation |
| | References Self | “XXX” on this object sets the same |
| | | animation “XXX” resulting in infinite |
| | | recursion during control code |
| | | execution. |
| WARNING | Overlapping | This object has a stimulus definition |
| | Stimulus | which overlaps with another object |
| | | that also has a stimulus definition. |
| | | This could result in both stimuli |
| | | triggering at the same time. |
| INFO | Superfluous | This group object has no stimulus and |
| | Group | no animations. Consider removing the |
| | | group because it serves no purpose. |
| | | This reduces draw performance and |
| | | increases resource requirements (like |
| | | memory consumption). |
| WARNING | Animation With | The custom animation “XXX” for this |
| | Many Defined | object has many defined states. Each |
| | States | defined states is an entry in a state |
| | | machine table in the generated code. |
| | | This reduces runtime performance and |
| | | increases resource requirements (like |
| | | memory consumption). |

TABLE 2
TARGET-SPECIFIC RULES

| Type | Title | Description |
|---|---|---|
| ERROR | Object Not | This object is not allowed when |
| | Allowed | using the specified Target. The |
| | | generated code for this object |
| | | will not compile nor execute. |
| WARNING | Object Not | This object is not supported |
| | Supported | when using the specified Target. |
| | | This object will not be drawn |
| | | correctly when running on the |
| | | target hardware. |
| WARNING | Concave Filled | This filled polygon has a convex |
| | Polygons Not | shape which is not supported on |
| | Supported | this Target. This object will not |
| | | be drawn correctly when running |
| | | on the target hardware. |
| ERROR | Object Too Tall | This object is taller than allowed |
| | | when using the specified Target. |
| | | This object will not be drawn |
| | | correctly when running on the |
| | | target hardware. |
| ERROR | Object Too Wide | This object is wider than allowed |
| | | when using the specified Target. |
| | | This object will not be drawn |
| | | correctly when running on the |
| | | target hardware. |
| ERROR | Transformation | This object has a transformation |
| | Not Allowed | which is not allowed on the |
| | | specified Target. The generated |
| | | code for this object will not |
| | | compile nor execute. |
| WARNING | Transformation | This object has a transformation |
| | Not Supported | which is not supported on the |
| | | specified Target. This object |
| | | will not be drawn correctly when |
| | | running on the target hardware. |
| ERROR | Distort Not | This object has been distorted |
| | Allowed | using the Distort Tool which is |
| | | not allowed on the specified |
| | | Target. The generated code for |
| | | this object will not compile nor |
| | | execute. |
| WARNING | Distort Not | This object has been distorted |
| | Supported | using the Distort Tool which is |
| | | not supported on the specified |
| | | Target. This object will not be |
| | | drawn correctly when running on |
| | | the target hardware. |
| INFO | Object | This object has been transformed |
| | Transformed | which is performed using the |
| | | CPU for the specified Target. |
| | | This reduces performance on the |
| | | embedded hardware. |
| ERROR | Custom Animation | This object has a custom |
| | Not Allowed | animation (created using the |
| | | Animation Editor) which is not |
| | | allowed on the specified Target. |
| | | The generated code for this |
| | | object will not compile nor |
| | | execute. |
| WARNING | Custom Animation | This object has a custom |
| | Not Supported | animation (created using the |
| | | Animation Editor) which is not |
| | | supported on the specified |
| | | Target. This animation will not |
| | | function correctly when running |
| | | on the target hardware. |
| ERROR | Builtin Animation | This object is using the Builtin |
| | Not Allowed | Animation “XXX” which is not |
| | | allowed on the specified Target. |
| | | The generated code for this |
| | | object will not compile nor |
| | | execute. |
| WARNING | Builtin Animation | This object is using the Builtin |
| | Not Supported | Animation “XXX” which is not |
| | | supported on the specified |
| | | Target. This animation will not |
| | | function correctly when running |
| | | on the target hardware. |
| ERROR | Control Code Not | This object has control code |
| | Allowed | (created using the Control |
| | | Editor) which is not allowed on |
| | | the specified Target. The |
| | | generated code for this object |
| | | will not compile nor execute. |
| WARNING | Control Code Not | This object has control code |
| | Supported | (created using the Control |
| | | Editor) which is not supported |
| | | on the specified Target. The |
| | | control code will not function |
| | | when running on the target |
| | | hardware. |
| ERROR | Stimulus Not | This object has a stimulus |
| | Allowed | definition (created using the |
| | | Stimulus Editor) which is not |
| | | allowed on the specified Target. |
| | | The generated code for this |
| | | object will not compile nor |
| | | execute. |
| WARNING | Stimulus Not | This object has a stimulus |
| | Supported | definition (created using the |
| | | Stimulus Editor) which is not |
| | | supported on the specified |
| | | Target. The stimulus will not |
| | | function when running on the |
| | | target hardware. |
| ERROR | Timers Not | This object has a timer definition |
| | Allowed | (created using the Stimulus |
| | | Editor) which is not allowed on |
| | | the specified Target. The |
| | | generated code for this object |
| | | will not compile nor execute. |
| WARNING | Timers Not | This object has a timer definition |
| | Supported | (created using the Stimulus |
| | | Editor) which is not supported |
| | | on the specified Target. The |
| | | stimulus will not function when |
| | | running on the target hardware. |
| WARNING | Timer Period Too | This object has a timer definition |
| | Small | (created using the Stimulus |
| | | Editor) which executes faster |
| | | than the minimum recommended |
| | | value for the specified Target. |
| | | This timer may not function at |
| | | the desired periodicity on the |
| | | target hardware. |
| WARNING | Excessive Timer | This design project is using |
| | Count | XXX timers which can cause |
| | | performance issues on the target |
| | | hardware. |
| INFO | Object is Not | This object is at a fractional pixel |
| | Aligned to Grid | location. This could cause the |
| | | object to appear one pixel out of |
| | | position on the target hardware. |
| INFO | Object Has | This object has a non-integer |
| | Fractional | size on the display. This could |
| | Dimensions | cause the object to appear one |
| | | pixel out of position on the target |
| | | hardware. |
| INFO | Object Outside of | This object is not inside a |
| | Display Object | Display Object. Only objects |
| | | inside a Display Object will be |
| | | drawn on the target hardware. |
| ERROR | Transparency Mask | This object has a transparency |
| | Not Supported | mask which is not supported on |
| | | the specified Target. This object |
| | | will not be drawn correctly when |
| | | running on the target hardware. |
| INFO | Transparency Mask | This object has a transparency |
| | | mask which is not as efficient as |
| | | using an image with transparent |
| | | pixels. Consider replacing this |
| | | image with a new image that has |
| | | the masked pixels already set as |
| | | transparent. |
| ERROR | Required Object | The specified Target requires |
| | Missing | that the “XXX” object be present |
| | | in the design project. |
| ERROR | Missing Required | This object requires the “XXX” |
| | Property | property in order to function |
| | Definition | correctly with the specified |
| | | Target. The generated code for |
| | | this object will not compile nor |
| | | execute. |
| ERROR | Too Many Objects | No more than “XXX” objects of |
| | | this type may be used with the |
| | | specified Target. |
| ERROR | Opacity Not | This object has an opacity less |
| | Allowed | than 100% which is not allowed |
| | | on the specified Target. The |
| | | generated code for this object |
| | | will not compile nor execute. |
| WARNING | Opacity Not | This object has an opacity less |
| | Supported | than 100% which is not |
| | | supported on the specified |
| | | Target. This animation will not |
| | | function correctly when running |
| | | on the target hardware. |

TABLE 3
TARGET-SPECIFIC RESOURCE RULES

| Type | Title | Calculation |
|---|---|---|
| INFO | Object RAM Size | Accumulates RAM total for the |
| | | design based upon objects used. |
| INFO | Object ROM Size | Accumulates ROM total for the |
| | | design based upon objects used. |
| INFO | Image Memory RAM Size | Accumulates RAM total for the |
| | | all images of the specified |
| | | format. |
| INFO | Image Memory ROM Size | Accumulates ROM total for the |
| | | all images of the specified |
| | | format. |
| INFO | Stack Size Requirement | Accumulates total memory |
| | | required for stack. |
| INFO | Engine RAM Size | RAM Required for the Engine |
| INFO | Engine ROM Size | ROM Required for the Engine |
| INFO | Font Count | Total number of font face + size |
| | | combinations |

One type of validation rule (exemplified by the rules in Table 1) might not relate to any particular embedded system but might impose general restraints on the user interface design, such as avoiding the use of unnecessary, high-demand animations, and/or the like. Such rules can be based on metrics measured through simulating the UI design (or estimated based on the objects in the design), and can provide feedback on potential performance bottlenecks or other issues. These types of validation rules might be applicable regardless of which target embedded system is selected. In other cases, some rules might be hybrid rules; for example, a generic rule might just be a warning for some target but might impose a hard constraint on other target systems.

A second type of validation rule (exemplified by the rules in Table 2) might relate to various target embedded systems on which the UI can be compiled to run. This type of rule can relate to the performance characteristics of the target embedded system, such as the characteristics of the processor(s) of the embedded system (which can be, for example, a System on a Chip (“SoC”) with a number of different general and special purpose processors), display characteristics of the system (such as resolution, screen size, color depth, and the like), characteristics of user input device(s) for the system (such as whether the display can be used as a touch screen, and if so, the performance characteristics of the touch screen, such as input resolution, multi-touch capabilities, and the like; the nature and/or performance of other input devices, such as knobs, sliders, keyboards, mice, etc.) and/or any other characteristics that might differentiate the abilities of one embedded system from those of another.

A third type of rule (exemplified by the rules in Table 3) might be based on resource constraints or targets. Such a rule might not account for the precise nature of the target system but might instead relate to more generalized characteristics, such as an amount of RAM, video RAM, processor cycles, etc. (regardless of the embedded platform) that are available to the UI. For instance, the developer might want to constrain the UI, regardless of the target system, to using no more than a specific amount of RAM. Such rules can be used to validate a UI design against such resource constraints, separate from the actual performance characteristics of the selected target embedded system(s).

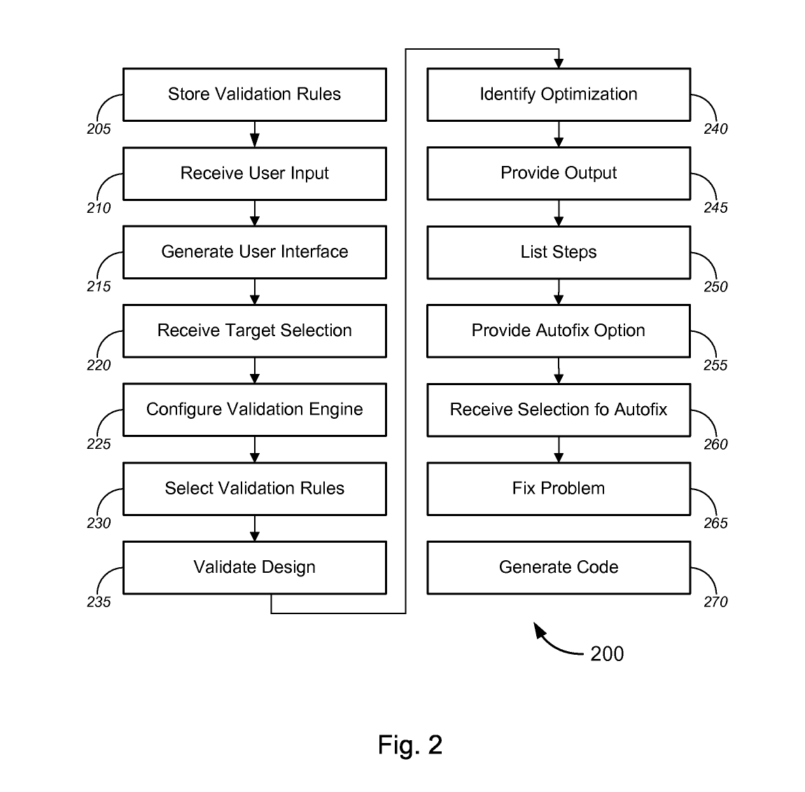

In operation (one mode of which is described further below with regard to FIG. 2), the design software 105 can provide tools for a user to create a UI (e.g., in a design pane 120 of the application) and can receive user input with these tools. The software 105 can also receive a selection of one (or more) target embedded system on which the UI is intended to run. Based on this selection, the validation engine 110 can select, from the data store 115, any applicable validation rules, and can validate the design of the UI against those rules. The output of the validation exercise can be displayed by the design software 105, perhaps in a separate validation pane 125 (so that the UI design and the validation output can be viewed simultaneously and separately).

As used herein, the term “validation engine” can mean any device or software program that applies validation rules to validate a user interface design, as described herein. A validation engine can take any suitable form. For example, in some embodiments, e.g., as illustrated by FIG. 1B, the functionality of the validation engine 110 can be divided into two components, a validation component 130 and a code generation component 135. On other cases, e.g., as illustrated by FIG. 1C, the function of the validation engine 110 might be further divided into a metrics measurement module 140, which can perform metrics measurement on a user interface design (e.g., to determine the resources used by the design on the target system and/or to apply validation rules such as those listed in Table 3. These components, while illustrated as part of the validation engine 110 conceptually, can be arranged together within the same application or module (e.g., the validation engine 110) or can be separate applications or components, depending on the embodiment. More generally, it should be appreciated that the functionality ascribed by this document to the validation engine 110 can be divided among a plurality of components, modules, or applications. Thus, for example, a validation component 130 can perform validation operations and/or identify possible optimizations within the code, while the code generation component 135 might produce code that fixes issues identified by the validation component, produce optimized code (and/or identify such optimizations), etc. A number of other functional arrangements are possible within the various embodiments.

FIG. 2 illustrates various methods (described generically with respect to the method 200 depicted on FIG. 2) that can be used to generate and/or validate a UI in accordance with various embodiments. While the techniques and procedures are depicted on FIG. 2 and/or described in a certain order for purposes of illustration, it should be appreciated that certain procedures may be reordered and/or omitted within the scope of various embodiments. Moreover, while the methods illustrated by FIG. 2 can be implemented by (and, in some cases, are described below with respect to) the system 100 of FIG. 1A (or components thereof), these methods may also be implemented using any suitable hardware implementation. Similarly, while the system 100 of FIG. 1A (and/or components thereof) can operate according to the methods illustrated by FIG. 2 (e.g., by executing instructions embodied on a computer readable medium), the system 100 can also operate according to other modes of operation and/or perform other suitable procedures.

The method 200 comprises storing a plurality of validation rules in a data store (block 205). As mentioned above, a variety of different rules can be supported, and some of them are described the '158 Application and in Tables 1-3 above. The method 200 can further comprise receiving user input from a user (block 210). In an aspect, this user input might include, for example, receiving input with user interface design software via a variety of drawing tools to generate a UI design for an embedded application. The method 200, then, can include, at block 215, generating a model of a UI for one or more embedded systems, based at least in part on the user input. In an aspect, the model of the UI can include some or all of the UI components that would be included in the UI when executing on the embedded system, except that it is simulated within the design software itself.

At block 220, the method 200 can include receiving a selection of one or more target embedded systems on which the UI is intended to execute. As used herein, the term “embedded system” means some or all of the hardware necessary to run a specialized embedded application within a larger system. Examples can include a control system (or various subsystems) within an automobile, control systems for appliances, and/or the like.

The description (or definition) of a particular embedded system within the design software can include any number of characteristics that might be relevant to the ability of the embedded system to execute the embedded application and/or the UI thereof. In some cases, that definition might include only the nature and/or characteristics of the processor(s) employed by the embedded system. In other cases, the definition might include the characteristics of displays, user input devices, and/or any other features that would affect the ability of an embedded system to execute the designed UI.

A variety of techniques can be used to receive the selection of the target embedded systems. For example, the design software might include a drop-down list (or other mechanism) that lists potential target systems from which the user can select. The design software might also include a button (or other mechanism) that the user can select to validate the design of the UI against the selected target system. In other cases, the design software and/or validation engine might perform the validation in real time, as the UI is designed, in which case no such button might be needed. For example, the validation engine might validate each new object, as objects are added by the designer (user), automatically and without user input, against whatever target system(s) the user specified previously.

In some cases, the user will be given the option to select a level of validation and/or optimization that should be performed. Thus, in some cases, the method 200 might comprise, at block 225, configuring a validation engine to perform a specified a level of validation or optimization to be performed by the validation engine, based, in some cases, on user input and/or specified preferences. For example, the user might be given the option to select settings for ‘strong’ or ‘weak’ validation, which could configure the validation engine to define which validation rules are applied (e.g., for strong validation, apply rules that would result in errors or warnings, while for weak validation, apply only rules that would trigger errors) and/or might still apply all applicable rules but suppress some output of the validation engine depending on the settings. Likewise, engine might be configurable to turning on or off optimization or for configuring optimization to be ‘high’, ‘medium’, or ‘low,’ which could result in the application of different optimization rules, routines, analysis, and/or output. The configuration of the validation engine (or components thereof) thus can operate together with target selection to further define the rules that should be used to validate the design and/or the output that should be provided from the validation engine (or components thereof)

At block 230, then, the method 200 comprises selecting one or more validation rules from the data store. This selection can be based in part or in whole on the user's selection of the target system. For example, in some cases, the only validation rules might be target-specific, while in other cases, some of the validation rules might be generic (“general” or “standard,” as described herein and in the '158 Application) to all target systems. Each validation rule might have a rule definition (including a rule identifier for each rule), and the system might store target rule specifications correlating target systems with the various validation rules that apply to each target system. Hence, when a target system is selected, the system can identify and select all rules that apply to that target system.

The method 200, then can include validating the design of the UI against the validation rules (block 235). In one aspect, this validation can comprise inspecting every object within the design of the UI and ensuring that each object violates none of the selected rules. For instance, if a particular validation rule for a target does not allow animations of a particular type, the validation engine can scan the UI design to identify any animations of that particular type. In some cases, the validation might be performed automatically, as the user interface is designed; in other cases, the validation might be performed based on user input, such as a validation command.

At block 240, the method 200 can comprise identifying one or more optimizations in the design of the user interface. In some cases, the design software can identify such optimizations automatically. A number of different optimizations can be identified. For example, in one embodiment, the software (or component thereof, such as validation engine and/or code generator) can identify optimizations in the number of lines of code (LOC) necessary to implement the user interface (e.g., by reducing the number of LOC through use of more efficient algorithms or reduction of redundant code). In other cases, the optimization might reduce the memory footprint (or other resources used) on the target system when the user interface is implemented on that target system. In other cases, the optimization can result in a performance increase when the user interface runs on the target system (e.g., less lag in the display of data with the user interface, better graphic performance, etc.).

At block 245, the method 200 can include providing output indicating a validation status of the UI design. The output can take a number of forms. For example, in some cases, the output might be displayed directly to the user through the design software (e.g., using a validation pane as described above). In other cases, the output can be saved to a file, which can be loaded (at the time, or at a later time) by the design software.

In some cases, the output will indicate that the design is valid for the target system, in which no further information need be provided. In other cases, however, the validation process might indicate some validation problems. In that case, the output can include a variety of different information. For example, in some cases, the method 200 can include providing (e.g., with the validation status output) a list of steps that the user can take to remedy a particular identified problem (block 250). In other cases, the design software might be able to fix the problem without the need for user interaction. In such cases, the method might comprise, at block 255, providing, e.g., with the design software, an autofix option to instruct the software to correct the problem automatically, without further user interaction. If the user selects this autofix option (block 260), for example, by pressing a button in the software or selecting a hyperlink in the output within the validation pane, the method can comprise taking whatever actions are necessary to correct the problem (block 265) without further user interaction.

A number of different problems might be identified by the validation process. Some problems might prevent compilation of the code, while other problems might allow for compilation but might produce undesirable results when execution of the code is attempted on the target system. Other problems might merely be warnings (for example, performance degradation warnings) that can be disregarded at the user's discretion. Examples of problems that can be identified during validation include animations, control codes, or stimulations in the UI design that the embedded system cannot support, alignment or size of objects in the UI design, and/or the like. Tables 1-3 list several exemplary problems (and the related validation rules) that can occur in a UI design. Problems can include target-specific problems (which might be flagged by target-specific rules), such as an animation that the target does not support, a control code that the target does not support, a stimulus that the target does not support, or the like. Other problems might be generic problems, such as problems in the alignment or size of an object in the design (which could also be target-dependent as well).

In some cases, the output can list (or otherwise identify) for the user any optimization that has been identified by the tool. The output can also provide the user with a selection to instruct the software to perform the optimization automatically. In other cases, the output might identify a location in the code (which might be user-generated or generated by the tool) where the possible optimization exists and allow the user to determine what action to take. In an aspect, optimization opportunities can be handled in similar fashion to validation errors (even though such non-optimized code might not technically be considered an error).

Once all of the validation errors have been fixed, and based (in some cases, at least) on user input, the method 200 can comprise generating code (block 270) to implement the UI on the target system. In some cases, this code might be compiled code that is directly executable on the target system, while in other cases, the generated code might be source code that can be compiled later to produce an executable. In particular cases, the code can be generated by a code generator module, which can be part of a validation engine or separate from a validation engine, depending on the embodiment. If the tool has identified optimization opportunities (and/or the user has specified that the optimizations should be implemented automatically by the tool), the generated code might be optimized to take advantage of these opportunities.

FIG. 3 provides a schematic illustration of one embodiment of a computer system 300 that can perform the methods provided by various other embodiments, as described herein, and/or can function as a computer system for generating and/or validating a UI for an embedded system. It should be noted that FIG. 3 is meant only to provide a generalized illustration of various components, of which one or more (or none) of each may be utilized as appropriate. FIG. 3, therefore, broadly illustrates how individual system elements may be implemented in a relatively separated or relatively more integrated manner.

The computer system 300 is shown comprising hardware elements that can be electrically coupled via a bus 305 (or may otherwise be in communication, as appropriate). The hardware elements may include one or more processors 310, including without limitation one or more general-purpose processors and/or one or more special-purpose processors (such as digital signal processing chips, graphics acceleration processors, and/or the like); one or more input devices 315, which can include without limitation a mouse, a keyboard and/or the like; and one or more output devices 320, which can include without limitation a display device, a printer and/or the like.

The computer system 300 may further include (and/or be in communication with) one or more storage devices 325, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 300 might also include a communications subsystem 330, which can include without limitation a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 330 may permit data to be exchanged with a network (such as the network described below, to name one example), with other computer systems, and/or with any other devices described herein. In many embodiments, the computer system 300 will further comprise a working memory 335, which can include a RAM or ROM device, as described above.

The computer system 300 also may comprise software elements, shown as being currently located within the working memory 335, including an operating system 340, device drivers, executable libraries, and/or other code, such as one or more application programs 345, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 325 described above. In some cases, the storage medium might be incorporated within a computer system, such as the system 300. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer system 300 and/or might take the form of source and/or installable code, which, upon compilation and/or installation on the computer system 300 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 300) to perform methods in accordance with various embodiments of the invention. According to a set of embodiments, some or all of the procedures of such methods are performed by the computer system 300 in response to processor 310 executing one or more sequences of one or more instructions (which might be incorporated into the operating system 340 and/or other code, such as an application program 345) contained in the working memory 335. Such instructions may be read into the working memory 335 from another computer readable medium, such as one or more of the storage device(s) 325. Merely by way of example, execution of the sequences of instructions contained in the working memory 335 might cause the processor(s) 310 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 300, various computer readable media might be involved in providing instructions/code to processor(s) 310 for execution and/or might be used to store and/or carry such instructions/code (e.g., as signals). In many implementations, a computer readable medium is a non-transitory, physical and/or tangible storage medium. Such a medium may take many forms, including but not limited to, non-volatile media, volatile media, and transmission media. Non-volatile media includes, for example, optical and/or magnetic disks, such as the storage device(s) 325. Volatile media includes, without limitation, dynamic memory, such as the working memory 335. Transmission media includes, without limitation, coaxial cables, copper wire and fiber optics, including the wires that comprise the bus 305, as well as the various components of the communication subsystem 330 (and/or the media by which the communications subsystem 330 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 310 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 300. These signals, which might be in the form of electromagnetic signals, acoustic signals, optical signals and/or the like, are all examples of carrier waves on which instructions can be encoded, in accordance with various embodiments of the invention.

The communications subsystem 330 (and/or components thereof) generally will receive the signals, and the bus 305 then might carry the signals (and/or the data, instructions, etc. carried by the signals) to the working memory 335, from which the processor(s) 305 retrieves and executes the instructions. The instructions received by the working memory 335 may optionally be stored on a storage device 325 either before or after execution by the processor(s) 310.

As noted above, a set of embodiments comprises systems for generating and/or validating UI designs for embedded systems. FIG. 4 illustrates a schematic diagram of a system 400 that can be used in accordance with one set of embodiments. The system 400 can include one or more user computers 405. A user computer 405 can be a general purpose personal computer (including, merely by way of example, desktop computers, tablet computers, laptop computers, handheld computers, and the like, running any appropriate operating system, several of which are available from vendors such as Apple, Microsoft Corp., and the like) and/or a workstation computer running any of a variety of commercially-available UNIX™ or UNIX-like operating systems. A user computer 405 can also have any of a variety of applications, including one or more applications configured to perform methods provided by various embodiments (as described above, for example), as well as one or more office applications, database client and/or server applications, and/or web browser applications. Alternatively, a user computer 405 can be any other electronic device, such as a thin-client computer, Internet-enabled mobile telephone, and/or personal digital assistant, capable of communicating via a network (e.g., the network 410 described below) and/or of displaying and navigating web pages or other types of electronic documents. Although the exemplary system 400 is shown with three user computers 405, any number of user computers can be supported.

Certain embodiments operate in a networked environment, which can include a network 410. The network 410 can be any type of network familiar to those skilled in the art that can support data communications using any of a variety of commercially-available (and/or free or proprietary) protocols, including without limitation TCP/IP, SNA™, IPX™, AppleTalk™, and the like. Merely by way of example, the network 410 can include a local area network (“LAN”), including without limitation a fiber network, an Ethernet network, a Token-Ring™ network and/or the like; a wide-area network; a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments can also include one or more server computers 415. Each of the server computers 415 may be configured with an operating system, including without limitation any of those discussed above, as well as any commercially (or freely) available server operating systems. Each of the servers 415 may also be running one or more applications, which can be configured to provide services to one or more clients 405 and/or other servers 415.

Merely by way of example, one of the servers 415 may be a web server, which can be used, merely by way of example, to process requests for web pages or other electronic documents from user computers 405. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 405 to perform methods of the invention.

The server computers 415, in some embodiments, might include one or more application servers, which can be configured with one or more applications accessible by a client running on one or more of the client computers 405 and/or other servers 415. Merely by way of example, the server(s) 415 can be one or more general purpose computers capable of executing programs or scripts in response to the user computers 405 and/or other servers 415, including without limitation web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including without limitation those commercially available from Oracle™, Microsoft™, Sybase™, IBM™ and the like, which can process requests from clients (including, depending on the configuration, dedicated database clients, API clients, web browsers, etc.) running on a user computer 405 and/or another server 415. In some embodiments, an application server can create web pages dynamically for displaying the information in accordance with various embodiments, such as the design pane and/or validation pane of the design software. Data provided by an application server may be formatted as one or more web pages (comprising HTML, JavaScript, etc., for example) and/or may be forwarded to a user computer 405 via a web server (as described above, for example). Similarly, a web server might receive web page requests and/or input data from a user computer 405 and/or forward the web page requests and/or input data to an application server. In some cases a web server may be integrated with an application server.

In accordance with further embodiments, one or more servers 415 can function as a file server and/or can include one or more of the files (e.g., application code, data files, etc.) necessary to implement various disclosed methods, incorporated by an application running on a user computer 405 and/or another server 415. Alternatively, as those skilled in the art will appreciate, a file server can include all necessary files, allowing such an application to be invoked remotely by a user computer 405 and/or server 415.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 420. The location of the database(s) 420 is discretionary: merely by way of example, a database 420a might reside on a storage medium local to (and/or resident in) a server 415a (and/or a user computer 405). Alternatively, a database 420b can be remote from any or all of the computers 405, 415, so long as it can be in communication (e.g., via the network 410) with one or more of these. In a particular set of embodiments, a database 420 can reside in a storage-area network (“SAN”) familiar to those skilled in the art. (Likewise, any necessary files for performing the functions attributed to the computers 405, 415 can be stored locally on the respective computer and/or remotely, as appropriate.) In one set of embodiments, the database 420 can be a relational database, such as an Oracle database, that is adapted to store, update, and retrieve data in response to SQL-formatted commands. The database might be controlled and/or maintained by a database server, as described above, for example.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method of validating user interface designs for automobile control systems, the method comprising:
storing, in a data store, a plurality of validation rules to validate user interface designs for automobile control systems;
receiving, with user interface design software running on a computer system, user input;
generating, with the user interface design software, a model of a user interface for an embedded application for an automobile control system, based at least in part on the user input;
receiving, with the user interface design software, a user selection of a target embedded system on which the user interface will run, the target embedded system having specified characteristics;
selecting, with a validation engine running on the computer system, one or more validation rules from the data store, based at least in part on the user selection of the target embedded system;
validating, with the validation engine, a design of the user interface with one or more validation rules; and
providing, with the user interface design software, output indicating a validation status of the design of the user interface.

2. A method, comprising:
storing, in a data store, a plurality of validation rules to validate user interface designs for embedded systems;
receiving, with user interface design software running on a computer system, user input;
generating, with the user interface design software, a model of a user interface for an embedded application, based at least in part on the user input;
receiving, with the user interface design software, a user selection of a target embedded system on which the user interface will run, the target embedded system having specified characteristics;
validating, with the validation engine running on the computer system, a design of the user interface with one or more validation rules; and
providing, with the user interface design software, output indicating a validation status of the design of the user interface.

3. The method of claim 2, wherein the user interface design software comprises the validation engine.

4. The method of claim 2, further comprising:
generating code executable on the target embedded system to implement the user interface.

5. The method of claim 2, wherein at least one of the one or more validation rules is based on performance characteristics of the target embedded system.

6. The method of claim 2, wherein the output identifies a problem with the design of the user interface.

7. The method of claim 6, wherein the output identifies one or more steps to be taken by a user to correct the problem.

8. The method of claim 6, wherein the output provides a user with an option to instruct the user interface design software to correct the problem automatically, the method further comprising correcting the problem.

9. The method of claim 6, wherein the problem is an animation, in the design of the user interface, that the target embedded system does not support.

10. The method of claim 6, wherein the problem is a control code, in the design of the user interface, that the target embedded system does not support.

11. The method of claim 6, wherein the problem is an alignment or size of one or more objects in the design of the user interface.

12. The method of claim 6, wherein the problem is a definition of a stimulus, in the design of the user interface, that the target embedded system does not support.

13. The method of claim 6, wherein the problem prevents code for the user interface from compiling.

14. The method of claim 6, wherein the problem prevents compiled code for the user interface from executing properly on the target embedded system.

15. The method of claim 2, further comprising:
identifying, with the user interface design software, an optimization for the user interface.

16. The method of claim 15, wherein the output provides a user with a selection for the user interface design software to perform the optimization automatically.

17. The method of claim 16, further comprising generating code automatically, with the user interface design software, to perform the optimization, in response to the user's selection.

18. The method of claim 15, wherein the optimization results in a performance increase for the user interface when run on the target embedded system.

19. The method of claim 15, wherein the optimization results in a decrease of an amount of resources consumed by the user interface when run on the target embedded system.

20. The method of claim 15, wherein the optimization results in a decrease of a number of lines of code generated by the user interface design software to implement the user interface on the target embedded system.

21. The method of claim 2, wherein at least one of the one or more rules calculates an amount of resources used by the user interface on the target embedded system.

22. The method of claim 2, further comprising selecting, with the validation engine, the one or more validation rules from the data store, based at least in part on the user selection of the target embedded system

23. The method of claim 2, wherein the user interface design software comprises a first pane for a user to provide the user input to generate the user interface and a second pane to display the output.

24. The method of claim 2, wherein the specified characteristics of the target embedded system include processor characteristics of the target embedded system.

25. The method of claim 2, wherein the specified characteristics of the target embedded system include display device characteristics of the target embedded system.

26. The method of claim 2, wherein the specified characteristics of the target embedded system include one or more input device characteristics of the target embedded system.

27. The method of claim 2, wherein the validation engine validates the design based on receiving a validation command from a user.

28. The method of claim 2, wherein the validation engine validates the design based on a previous user selection of the target embedded system.

29. The method of claim 2, wherein the user interface is a user interface for an automobile.

30. The method of claim 2, wherein the user interface is a user interface for a medical device.

31. The method of claim 2, further comprising configuring the validation engine to perform a specified a level of validation or optimization to be performed by the validation engine.

32. An apparatus, comprising:
a non-transitory computer readable medium having encoded thereon a set of instructions executable by one or more computers to perform one or more operations, the set of instructions comprising:
instructions to store, in a data store, a plurality of validation rules to validate user interface designs for embedded systems;
instructions to receive user input;
instructions to generate a model of a user interface for an embedded application, based at least in part on the user input;
instructions to receive a user selection of a target embedded system on which the user interface will run;
instructions to validate a design of the user interface with one or more validation rules; and
instructions to provide output indicating a validation status of the design of the user interface.

33. A computer system, comprising:
one or more processors; and
a non-transitory computer readable medium in communication with the one or more processors, the computer readable medium having encoded thereon a set of instructions executable by the computer system to perform one or more operations, the set of instructions comprising:
instructions to store, in a data store, a plurality of validation rules to validate user interface designs for embedded systems;
instructions to receive user input;
instructions to generate a model of a user interface for an embedded application, based at least in part on the user input;
instructions to receive a user selection of a target embedded system on which the user interface will run;
instructions to validate a design of the user interface with one or more validation rules; and
instructions to provide output indicating a validation status of the design of the user interface.
